(19) United States
(12) Patent Application Publication
(10) Pub. No.: US 2016/0071083 A1
(43) Pub. Date: Mar. 10, 2016

(54) Database driven, dynamically configurable payment routing and responses based on payment types

(71) Applicant: Bradley Apps, Seattle, WA (US)

(72) Inventor: Bradley Apps, Cornubia (AU)

(21) Appl. No.: 14/482,990

(22) Filed: Sep. 10, 2014

(51) Int. Cl. G06Q 20/22

(52) U.S. Cl. CPC G06Q 20/22

(57) ABSTRACT

A transaction router includes an interface to a routing rules database and logic to analyze a transaction to determine a predetermined transaction type. The router selects a payment provider network from among a plurality of payment provider networks, the selection based on the transaction type and routing rules for the transaction type received from the routing rules database.

### CROSS-REFERENCE TO RELATED APPLICATIONS

Not Applicable.

### BACKGROUND OF THE INVENTION

Transactions in a payment or other value transfer network may be associated with a certain amount of risk for the account holder (the person transferring value, for example). This is because use of a single payment provider (Secure Pay, NAB, Braintree, etc.) to fulfill transactions inherently carries a certain amount of risk. However, the dynamic selection and use of alternate payment providers is usually not a facility that is practically available to account holders at transaction time.

### BRIEF SUMMARY OF THE INVENTION

Not Applicable.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates aspects of a payment process embodiment

FIG. 2 illustrates additional aspects of a payment process embodiment

FIG. 3 illustrates aspects of an embodiment of a process to handle a payment request

FIG. 4 illustrates aspects of an embodiment of a process to handle response codes

FIG. 5 rules based transaction processing system embodiment

FIG. 6 embodiment of a transaction routing system

FIG. 7 illustrates an embodiment of a machine to implement aspects of the described transaction routing system

### DETAILED DESCRIPTION OF THE INVENTION

### Glossary

“API” in this context refers to (Application Programming Interface) a set of defined entry points (e.g., “functions”) and controls (e.g., “parameters”) to those entry points, and output behavior (e.g., “return values”) to logic, that can be invoked to access specific functionality of the logic.

“Database” in this context refers to an organized collection of data (states of matter representing values, symbols, or control signals to device logic), structured typically into tables that comprise ‘rows’ and ‘columns’, although this structure is not implemented in every case. One column of a table is often designated a “key” for purposes of creating indexes to rapidly search the database.

“Database Table” in this context refers to a set of data elements (values) in machine memory associated into a model of vertical columns and horizontal rows, the cell being the unit where a row and column intersect. A table typically has a specified number of columns, but can have any number of rows. Each row may be identified by values appearing in a particular column subset, possibly identified as a unique key index. The data in a table does not have to be physically stored in the database with which the table is associated. “Views” is a term sometimes used to refer to dynamic tables generated at query time. One column of a table is often designated a “key” for purposes of creating indexes to rapidly search the database.

“dynamic” in this context refers to being changeable depending on immediate circumstances or determinations

“Email” in this context refers to a form of electronic or optical communications between devices, which takes the form of exchanging messages from an author to one or more recipients. Email communications typically operates across the Internet or other device networks.

“Gateway” in this context refers to a network device that serves as an interface to another network. Within enterprises, the gateway routes traffic from an internal network (e.g., LAN) to a wide area network such as the Internet or a private and/or secure payment provider or telecommunication carrier network. In homes, the gateway may be provided by the ISP that connects the home to the Internet. In enterprises, the gateway node often acts as a proxy server and a firewall.

“HTTP” in this context refers to (HyperText Transport Protocol), a standard World Wide Web client-server protocol used for the exchange of information (such as HTML documents, and client requests for such documents) between a browser and a Web server. HTTP includes a number of different types of messages which can be sent from the client to the server to request different types of server actions. For example, a “GET” message, which has the format GET, causes the server to return the document or file located at the specified URL.

“JSON” in this context refers to (JavaScript Object Notation) a text-based open standard designed for human-readable data interchange among machines. Derived from the JavaScript scripting language, JSON is a language for representing simple data structures and associative arrays.

“queue” in this context refers to a machine memory buffer having related data defining an order of its contents. Queues are often FIFO (first in first out) machine memory organizations.

“Router” in this context refers to logic that distributes digital information that is contained within a data packet. Each data packet contains address information that a router can use to determine if the source and destination are on the same network, or if the data packet must be transferred from one network to another. This transfer to another type of network is achieved by encapsulating the data with network specific protocol header information. When multiple routers are used in a large collection of interconnected networks, the routers exchange information about target system addresses, so that each router can build up a table showing the preferred paths between any two systems on the interconnected networks.

“User Interface” in this context refers to logic to receive signals from device inputs such as a mouse, keyboard, or microphone, and to correlate those inputs with visual features rendered on an optical display. A user interface determines how a human operator interacts with and controls a device. User interfaces are comprised of elements with which the human operator interacts to affect device behavior. Examples of user interface elements are (1) command language (text): the operator inputs program-specific instructions or codes into the device, (2) menus: the operator selects elements from displayed lists, (3) buttons: the operator selects (typically by clicking the mouse cursor on) defined areas of the display.

“World Wide Web” in this context refers to (“Web”) generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

“XML” in this context refers to eXtensible Markup Language, a standard that forms the basis for most modern markup languages. XML is an extremely flexible format that only defines “ground rules” for other languages that define a format for structured data designed to be interpreted by software on devices. XML by itself is not a data format. Examples of XML-based standards include xHTML, for creating web pages, RSS, for feeds of new information (such as news headlines), and SyncML, for managing personal data such as contacts, email, files, and events.

### Description

Described herein is a system providing a process and management interface for database driven, dynamically configurable payment routing based on payment types. The system further provides a process and management interface for database driven, dynamically configurable transaction response actions. The database design links a client to a payment provider, and links a payment provider response code to an action.

The system includes an on-line fully-hosted application providing dynamic credit card payment routing to different payment providers. In one embodiment the payment providers available are Secure Pay, NAB, Ethan (EP2 Payments), Braintree, Westpac, and EziDebit. The system employs dynamic rules based on a payment type to determine which provider will process a payment. This enables a business (an account holder within the system) to spread credit risk, cash flow and fees payable between payment providers, and provides redundancy and fault tolerance by allowing immediate failover to an alternative payment provider in the case of processing failure by a primary payment provider.

A system account holder (used herein interchangeably with “customer”) configures their account with one or more supported payment providers. The system manages credit cards and related token generation for each of the relevant chosen payment providers. The account holder may utilize secure web based access to manage their routing configuration based on their business processes. The system provides for the configuration of options which the account holder may configure to retry a payment again with the same or different payment provider, depending on the response code returned from the payment provider.

A management interface for the system may provide for “master routing”, allowing selection of one provider for all payments, regardless of the payment type. The management interface may also provide “business process routing” to route transactions according to their type to a relevant payment provider. Payment types may be fully dynamic and database driven, allowing separate payment types where relevant to the individual account holder. Example payment TYPES are Web-Based Top Ups (i.e., adding value to a pre-paid card), Due Date Payments, Auto Renewal Payments, IVR/SMS Top Ups, and Initial Purchase Payments. Each account holder may set up their own custom payment types which are relative to different parts of their systems and/or business processes. The management interface provides a means to switch on business process routing, either with or without failover back to master routing.

The account holder can also set up a series of multi-dimensional rules based on each payment provider. This matrix of rules includes:
Monthly processing limits (amount and number) for each payment provider. When a limit is reached or is exceeded, the system will select the alternative provider automatically to process the further transactions. Limits may be set for all transactions, and/or for particular transaction TYPES, and/or for particular payees, type of goods or services, times, dates, and other transaction characteristics. This allows an account holder to limit their risk with any one provider.
Rate of processing for each payment provider. Relative to the above limits configured, the account holder can also select the system to look at the rate of processing for each particular payment processor. A rating may determine an average daily amount and number of transactions, and calculate a projection for the month. If the projection will exceed the limit set, the system will process with the alternate provider.
Combinations of amount and payment TYPE. For example, all Web Based Top Ups under $100 should go to Braintree; or all Initial Purchases over $200 should go to Secure Pay.
Day of week/holiday. The account holder can choose to process payments to different payment providers on different days of the week or set dates to process on or not. For example, payments made on Saturday or Sunday should be made to Secure Pay (as they do payment clearing on weekends) and the other days process on Ethan.

The database is structured to enable the functionality to be driven fully from configuration parameters and relationships within the database. This structure includes a table for the payment providers, and a table linking the providers to the account holders. This relational design is a many-to-many structure. In addition, the payment providers table stores the relevant configuration parameters' list which the individual provider requires (ie. Username, Merchant Identifier, etc.) and the providers to the account holders table stores the individual values for the account holder in an encrypted JSON structure.

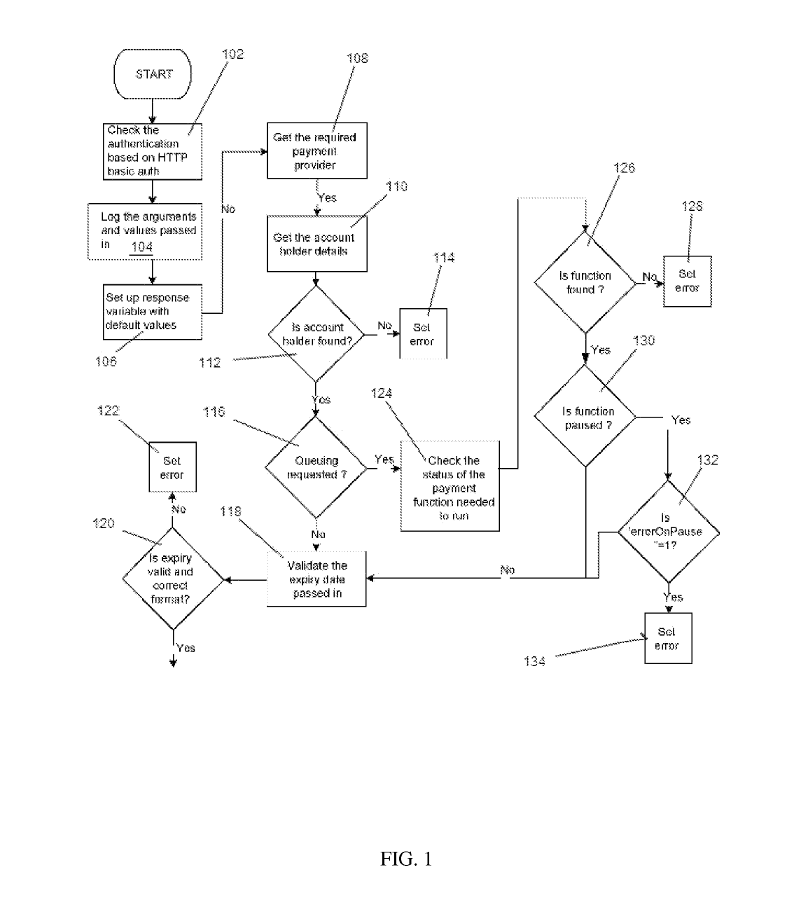

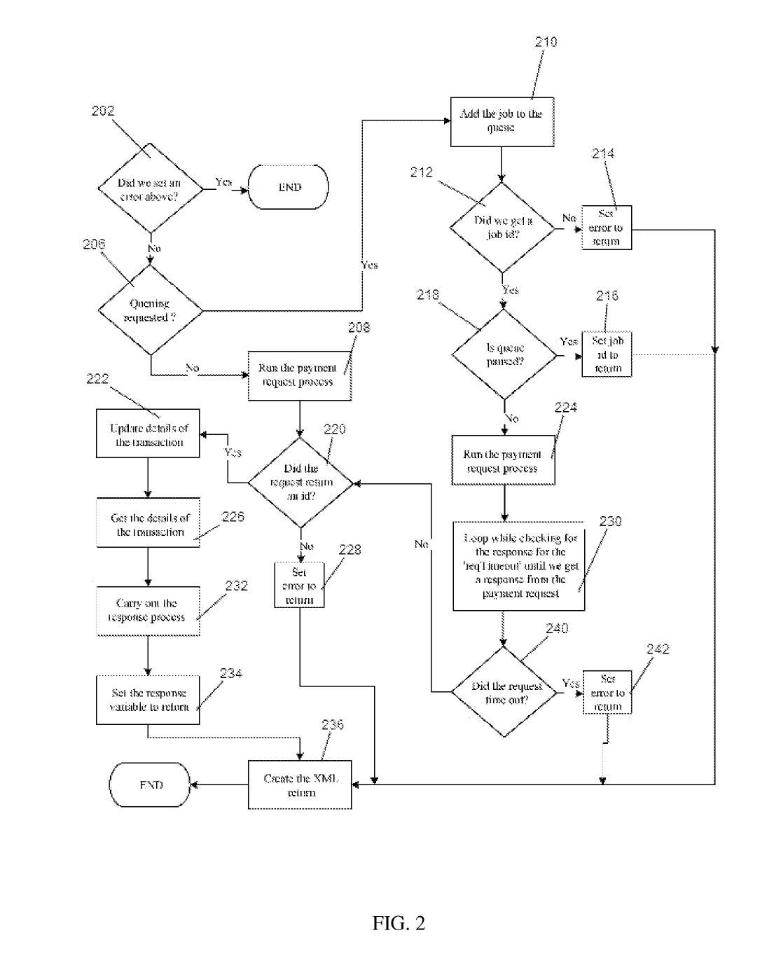

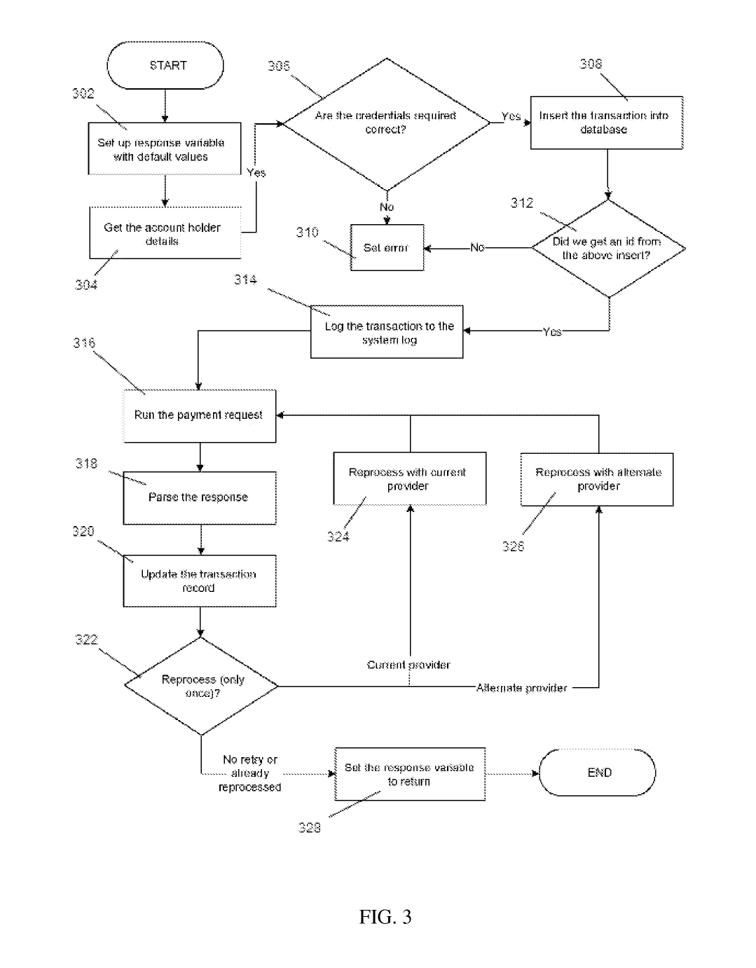

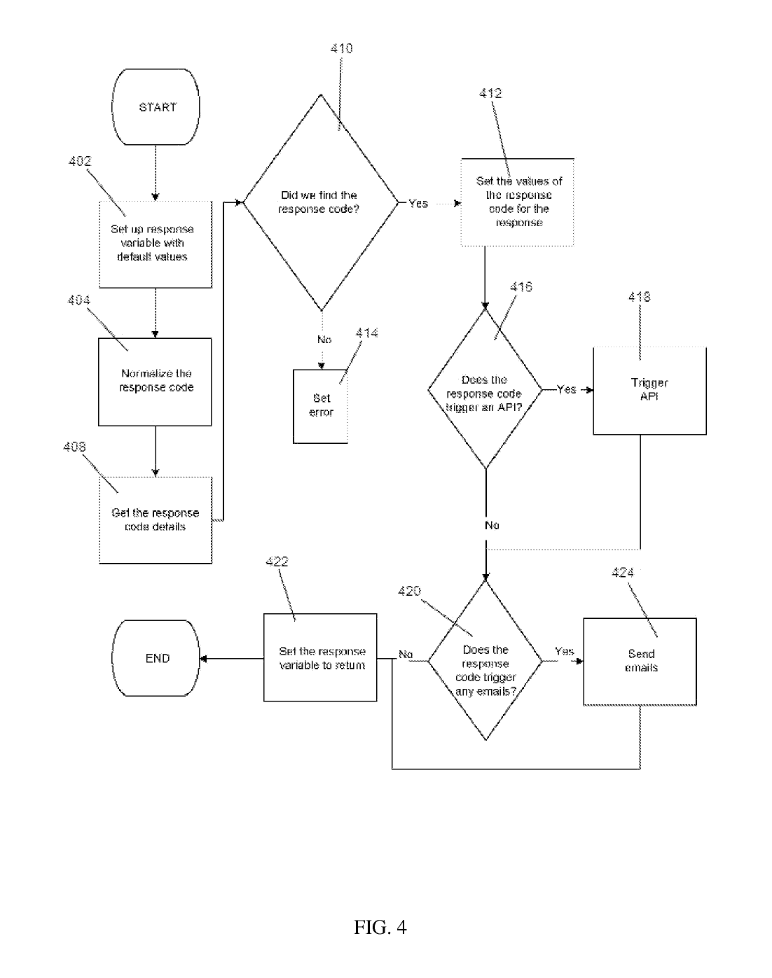

FIGS. 1 and 2 illustrate a payment process embodiment. The authentication of the user (e.g., account holder) is done, for example using HTTP basic authentication. The arguments and values passed in are logged. The response variable is set with default values. A check is made that the payment provider specified by the payment routing settings or the monthly processed limits has been configured. An error is set if there are no permissions. The account holder details are retrieved. An error is set if the account holder is not found. If a transaction queue is being utilized, a. a check is made as to the status of the payment function needed to run; b. an error is raised if the queue function not found; and c. and error is raised if the queue is paused and the option is passed to raise an error in this situation. The system validates the payment vehicle (e.g., credit card) expiry date passed in and raises an error if not of correct format. Processing continues if there is no error up to this point. The system checks if queuing is to be utilized, or not based on the request parameters. If queuing is to be utilized: i. add the transaction to the queue; ii. raise an error if no job id is returned; iii. if the queue is paused, return the job id only; iv. if the queue is not paused, loop, for the timeout threshold, while checking for a response from the payment request process (e.g., see FIG. 3); v. if the payment request process times out, return an error. If the request parameters dictate to not utilize queuing: i. run the payment request process (e.g., FIG. 3); set an error if no id is returned from the payment transaction. To complete the transaction: a. update the response details of the transaction; b. get the details of the transaction; c. carry out the response code process (e.g., FIG. 4); set the response variable to return; create the XML return.

With reference to component numbers, or a new transaction the account holder is authenticated (e.g., HTTP authentication) 102. Any values or arguments provided via a machine user interface are logged (104), and default response values (return codes for the transaction process) are configured 106. Next a payment provider is selected 108. This selection may be dynamically rules based, as described herein. Account holder details are retrieved (110), and if no account holder is found (112), an error is set (114). Otherwise the transaction proceeds.

If the transaction will utilize queuing (116), the payment function status is checked 124 and if found (126), checked for pause status (130). An error is set if the function isn't found 128. If the function is paused and the system is configured such that a paused payment function is an error state (132), an error is set 134. Otherwise if not paused (130), the expiration date of the payment vehicle is checked (118) and if expired (120) an error is set 122. Otherwise processing continues as illustrated in FIG. 2.

Referring to FIG. 2, if there is no error (202) preceding then if queuing is requested (206), the transaction is queued (210) and a job id is expected. If no job id is received from the queuing (212), an error is set 214. Otherwise check if queuing is paused (218). If yes, the job id is set as a return value from the process. If no, the payment request process is run (224, see FIG. 3) and the system waits for a response from this process (230) or else times out. On timeout (240), an error is set (242).

If queuing was not requested (206), the payment request process is run (208, see FIG. 3). If the process did not return an id (220), an error is set (228). Otherwise, details of the transaction are updated (222), retrieved (226), and the response process is executed (232, see FIG. 4). The response value to return is set (234), the XML return value is set (236), and the process concludes.

FIG. 3 illustrates an embodiment of a payment request process. The system sets a response variable with default values. The account holder credentials are retrieved. The credentials are validated as required for the payment gateway. The transaction is added into a database. An error is set if this does not result in an id being returned. The transaction is logged to the system log, and the request is processed with the payment provider. The response from the provider is parsed. The transaction record is updated. The response is processed to check if the transaction needs to be retried: a. retry again—reprocess the transaction with the current provider, OR; b. retry other provider—reprocess the transaction with the alternative provider, OR; c. no retry—continue without reprocessing. A result of the transaction is returned.

With reference to component numbers, response codes are set to default values (302) and account holder details are retrieved (304). If the details are not valid (306) an error is set (310). Otherwise the transaction is recorded in the transaction database (308). Recording the transaction should return an confirming id (312); if not, an error is set (310). The transaction is also logged in the system log (314) and the payment request is run (316). The response from running the payment process is parsed (318) and the transaction record is updated (320). If reprocessing of the payment request is needed (response indicates a problem) (322), the payment request is either reprocessed with the current provider (324) or the alternate provider (326). If there's no problem with the payment request or the maximum retries are up, response codes are set (328) and the process concludes.

FIG. 4 illustrates an embodiment of a process to process response codes. Depending on the response code returned from the payment provider for the transaction, there are options which the account holder can set to retry the payment again with the same or different payment provider. The number of retries is also configurable, as well as the same multi-dimensional rules as above will apply to the retry. The system sets up a response variable with default values. The response code is normalized. Details of the response code are retrieved from a database and the response code settings for the account holder are retrieved. The system sets an error if the response code isn't found in the database. The system sets the values of the response code for the response. If the response code includes an API trigger, the configured callback mechanism is invoked. The system will send emails or notifications based on the response code settings.

Referencing component numbers, response variables are set to default values (402) and these are normalized (404). Response code details are retrieved (408) and validated (410). If the validation fails (e.g., response code not found) an error is set (414). Otherwise the response values are set (412). One or more response codes may trigger a “callback” or other logic invocation (an application program interface or API entry point) (416). If so, the callback is invoked. If the response code is configured to trigger an email (420), emails with response data for the transaction are sent (424). Response values are set (422) and the process concludes.

### Drawings

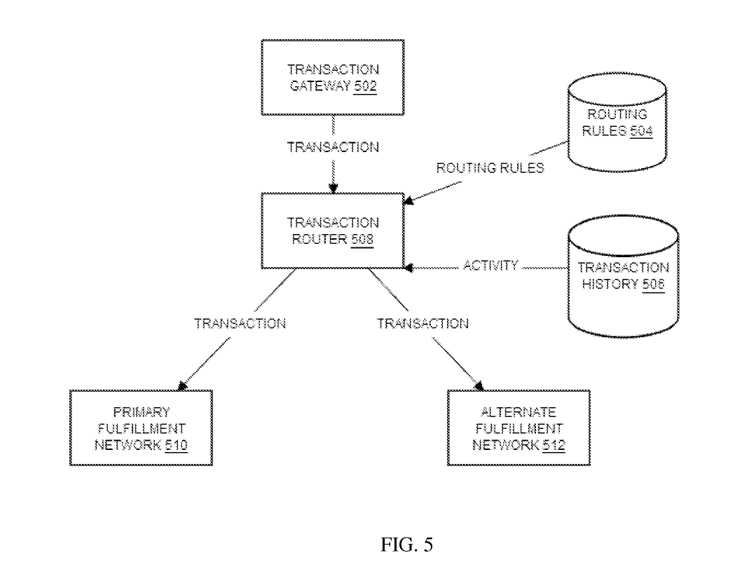

In FIG. 5, a transaction is received at a gateway 502. Routing rules from a transaction rule database 504 are retrieved for a transaction type. A transaction router 508 may route the transaction to a primary fulfillment network 510 or alternate fulfillment network 512 depending on the transaction type, as determined by the router 508. The router 508 may route the transaction based not only on its type, but also based on transaction activity as stored by a transaction history database 506. For example, if recent transaction activity utilizing the primary network 510 exceeds a total amount in a defined time period, the alternate network 512 may be selected. As another example, if the transaction has a certain predetermined type, and a rate of activity for that type of transaction on the primary network 510 exceeds a predetermined threshold, the alternate network 512 may be selected. Other examples of possible routing rules/behaviors are described supra.

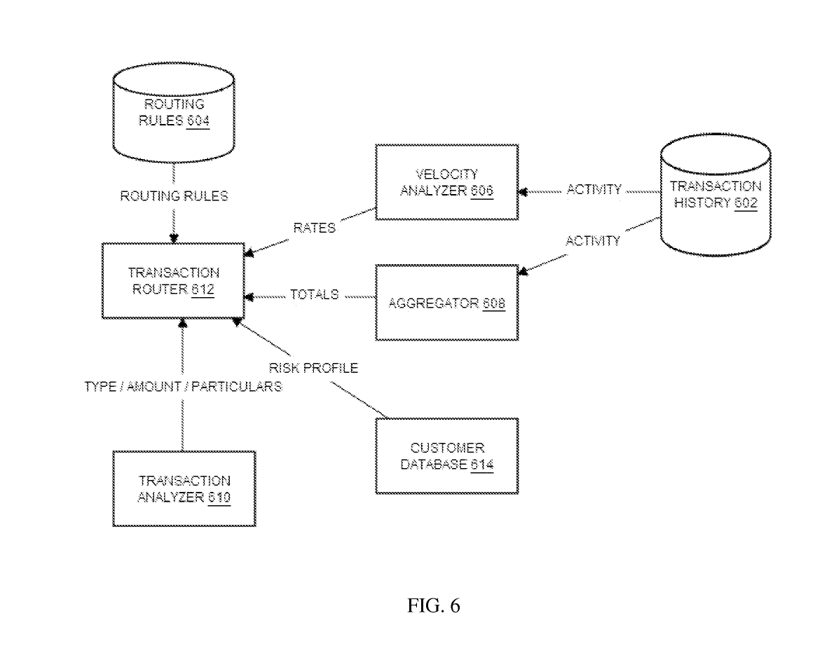

In FIG. 6, a transaction router 612 receives routing rules from a rules database 604, and also receives from a transaction analyzer 610 characteristics about the transaction (e.g., its predetermined type, its amount, the particulars of what goods/services are being transacted, the time/date/store location of the transaction, the payment mechanism details, etc.). Transaction activity for an account holder is extracted from a transaction history database 602 and applied to rate (velocity) module 606 and aggregator 608. A rate of transaction activity (in general, or for combinations of one or more transaction particulars) is provided to the router 612. Transaction totals (either in general, or for combinations of one or more transaction particulars) is provided to the router 612. The router 612 weighs one or more of the inputs against a customer risk profile from a customer (account holder) database 614. A customer's risk profile may be formed from an evaluation of the customer's willingness to take financial risks, as well as financial risks to which the customer is exposed due to their transactions with one or a combination of payment provider networks. A risk profile may identify an acceptable levels of risk the customer is prepared to accept, and combinations of payment provider network, transaction types, and other factors (as described herein) for the transactions associated with those levels. The risk profile may define probabilities of resulting negative effects of said combinations, and a definition of the potential costs and level of disruption to transaction processing or financial position for each risk. The system may dynamically adjust a customer's risk profile based on transaction behavior, such as quantity/rate/timing of certain types of transactions, or return values from payment provider networks, as previously described.

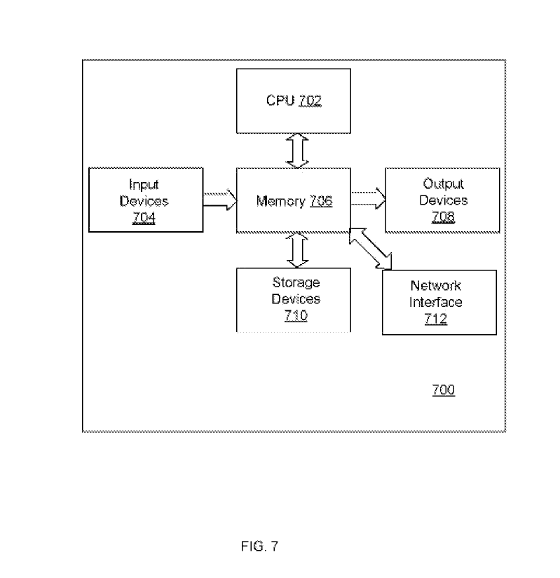

FIG. 7 illustrates a machine which can implement various features described herein (e.g., a transaction router device). Input devices 704 comprise transducers that convert physical phenomenon into machine internal signals, typically electrical, optical or magnetic signals. Signals may also be wireless in the form of electromagnetic radiation in the radio frequency (RF) range but also potentially in the infrared or optical range. Examples of input devices 704 are keyboards which respond to touch or physical pressure from an object or proximity of an object to a surface, mice which respond to motion through space or across a plane, microphones which convert vibrations in the medium (typically air) into device signals, scanners which convert optical patterns on two or three dimensional objects into device signals. The signals from the input devices 704 are provided via various machine signal conductors (e.g., busses or network interfaces) and circuits to memory devices 706. The memory devices 706 is typically what is known as a first or second level memory device, providing for storage (via configuration of matter or states of matter) of signals received from the input devices 704, instructions and information for controlling operation of the CPU 702, and signals from storage devices 730. Information stored in the memory devices 706 is typically directly accessible to processing logic 702 of the device. Signals input to the device cause the reconfiguration of the internal material/energy state of the memory device 706, creating in essence a new machine configuration, influencing the behavior of the device 700 by affecting the behavior of the CPU 702 with control signals (instructions) and data provided in conjunction with the control signals. Second or third level storage devices 730 may provide a slower but higher capacity machine memory capability. Examples of storage devices 730 are hard disks, optical disks, large capacity flash memories or other non-volatile memory technologies, and magnetic memories. The processing logic 702 may cause the configuration of the memory 706 to be altered by signals in storage devices 730. In other words, the CPU 702 may cause data and instructions to be read from storage devices 730 in the memory 706 from which may then influence the operations of CPU 702 as instructions and data signals, and from which it may also be provided to the output devices 708. The CPU 702 may alter the content of the memory of 706 by signaling to a machine interface of memory 706 to alter the internal configuration, and then converted signals to the storage devices 730 to alter its material internal configuration. In other words, data and instructions may be backed up from memory 706, which is often volatile, to storage devices 730, which are often non-volatile. Output devices 708 are transducers which convert signals received from the memory 706 into physical phenomenon such as vibrations in the air, or patterns of light on a machine display, or vibrations (i.e., haptic devices) or patterns of ink or other materials (i.e., printers and 3-D printers). Communication interface 712 receives signals from the memory 706 and converts them into electrical, optical, or wireless signals to other machines typically via a machine network. Communication interface 712 also receives signals from the machine network and converts them into electrical, optical, or wireless signals to the memory 706.

References to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other.

“Logic” refers to machine memory circuits, machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals.

These skilled in the art will appreciate that logic may be distributed throughout one or more devices, and/or may be comprised of combinations memory, media, processing circuits and controllers, other circuits, and so on. Therefore, in the interest of clarity and correctness logic may not always be distinctly illustrated in drawings of devices and systems, although it is inherently present therein.

The techniques and procedures described herein may be implemented via logic distributed in one or more computing devices. The particular distribution and choice of logic will vary according to implementation.

Those having skill in the art will appreciate that there are various logic implementations by which processes and/or systems described herein can be effected (e.g., hardware, software, and/or firmware), and that the preferred vehicle will vary with the context in which the processes are deployed. “Software” refers to logic that may be readily readapted to different purposes (e.g. read/write volatile or nonvolatile memory or media). “Firmware” refers to logic embodied as read-only memories and/or media. Hardware refers to logic embodied as analog and/or digital circuits. If an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations may involve optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory.

In a general sense, those skilled in the art will recognize that the various aspects described herein which can be implemented, individually and/or collectively, by a wide range of hardware, software, firmware, or any combination thereof can be viewed as being composed of various types of “circuitry.” Consequently, as used herein “circuitry” includes, but is not limited to, electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), circuitry forming a memory device (e.g., forms of random access memory), and/or circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

What is claimed is:

1. A transaction router, comprising:
an interface to a routing rules database;
logic to analyze a transaction to determine a predetermined transaction type; and
logic to select from among a plurality of payment provider networks a payment provider network to process the transaction, the selection based on the transaction type and routing rules for the transaction type received from the routing rules database.

2. The router of claim 1, further comprising:
logic to select the payment provider network based on a total amount transacted within a determined time period for the payment type.

3. The router of claim 1, further comprising:
logic to select the payment provider network based on a type of good or service transacted.

4. The router of claim 1, further comprising:
logic to select the payment provider network based on a total amount transacted for a type of good or service.

5. The router of claim 4, further comprising:
logic to select the payment provider network based on a total amount transacted for a type of good or service within a determined time period.

6. The router of claim 1, further comprising:
logic to select the payment provider network based on a rate of transactions for the payment type.

7. The router of claim 1, further comprising:
logic to select the payment provider network based on a day of the week.

8. The router of claim 7, further comprising:
logic to select the payment provider network based on a total amount transacted on the day of the week.

9. The router of claim 8, further comprising:
logic to select the payment provider network based on total amount transacted for a determined payment type on the day of the week.

10. The router of claim 1, further comprising:
logic to apply a customer risk profile to the payment type to dynamically determine the payment provider network to select for the transaction.

11. The router of claim 1, further comprising:
logic to select from among a plurality of payment provider networks a second payment provider network for the transaction, the selection of the second payment provider network based on the transaction type and routing rules received from the routing rules database for the transaction type and a return value from a payment provider network selected to process the transaction initially.

12. A transaction router, comprising:
an interface to a routing rules database;
logic to analyze a transaction to determine a predetermined transaction type; and
logic to select from among a plurality of payment provider networks a payment provider network to process the transaction, the selection based on routing rules for the transaction type determined from a combination of the payment type and a customer risk profile.

13. The router of claim 12, further comprising:
logic to ascertain a level of risk associated with utilizing a particular payment provider network to process the transaction type, the level of risk determined based on dynamic factors associated with the transaction, and the compare the determined level of risk to an acceptable level of risk for the transaction type specified by the customer risk profile.

14. The router of claim 12, further comprising:
logic to ascertain the level of risk based on a total amount transacted within a determined time period for the payment type.

15. The router of claim 12, further comprising:
logic to ascertain the level of risk based on a type of good or service transacted.

16. The router of claim 12, further comprising:
logic to ascertain the level of risk based on a total amount transacted for a type of good or service.

17. The router of claim 16, further comprising:
logic to set the level of risk based on a total amount transacted for a type of good or service within a determined time period.

18. The router of claim 12, further comprising:
logic to ascertain the level of risk based on a rate of transactions for the payment type.

19. The router of claim 12, further comprising:
logic to ascertain the risk based on the transaction type and routing rules received from the routing rules database for the transaction type and a return value from a payment provider network selected to process the transaction initially.
